(19) United States
(12) Patent Application Publication
(10) Pub. No.: US 2021/0214151 A1
(43) Pub. Date: Jul. 15, 2021

(54) Roller box

(71) Applicant: Inno-Sports Co., Ltd, Xiamen (CN)

(72) Inventor: Kwan Jun Choi, Xiamen (CN)

(73) Assignee: Inno-Sports Co., Ltd, Xiamen (CN)

(21) Appl. No.: 16/784,273

(22) Filed: Feb. 7, 2020

(30) Foreign Application Priority Data
Jan. 13, 2020 (CN) 202020065019.5

(51) Int. Cl. B65D 85/64; B65D 85/07; B65D 90/18; B65D 25/28; B65D 21/02

(52) U.S. Cl. CPC B65D 85/64; B65D 85/07; B65D 90/18; B65D 2585/649; B65D 21/0201; B65D 21/0209; B65D 25/2841

(57) ABSTRACT

The present invention relates to a roller box including a sealed box and at least one roller unit; the sealed box includes at least one first cavity and at least one second cavity; the at least one roller unit is disposed in the at least one first cavity.

### TECHNICAL FIELD

The present invention relates to the technical field of box, particularly to a roller box.

### BACKGROUND

Transportation of goods from one location to another location has many challenges. Saving cost and resources are important factors to be considered during transportation. Goods to be transported usually have an external packing and are normally transported by transport machine, such as trolly, truck, service cart, or just by humans. Transporting by machine will consume a large amount of resources, while transporting by humans will not only waste resources but also affect transportation efficiency.

### SUMMARY

The present invention provides a roller box to solve the shortcomings of the prior art.

In order to achieve the above objective of the invention, the following technical solutions are provided.

The present invention provides a roller box that including sealed box and at least one roller unit. The sealed box includes at least one first cavity and at least one second cavity, and the at least one roller unit is disposed in the at least one first cavity.

Further, the sealed box includes a top surface that can be opened, a first sidewall, a second sidewall, a third sidewall, a fourth sidewall and a bottom surface; the first sidewall is opposite to the second sidewall, and the third sidewall is opposite to the fourth sidewall; the bottom surface respectively meets the first sidewall, the second sidewall, the third sidewall and the fourth sidewall to define a first corner edge, a second corner edge, a third corner edge and a fourth corner edge.

Further, the at least one roller unit includes a plurality of roller units, the at least one first cavity includes first set of cavities, and the at least one second cavity includes second set of cavities; the plurality of roller units are disposed in the first set of cavities.

Further, the first set of cavities are symmetrically formed by concaving inward the sealed box from the first corner edge, and the second set of cavities are symmetrically formed by concaving inward the sealed box from the second corner edge; the first set of cavities and the second set of cavities are symmetrically arranged.

Further, each of the at least one roller unit includes the wheel with universal joint, spring rod and fixing sheet; first end of the spring rod is coaxially connected to the universal joint of the wheel, and second end of the spring rod is fixedly connected to midpoint of the fixing sheet.

Further, each of the at least one first cavity includes first upper portion and first side portion, and each of the at least one second cavity includes second upper portion and second side portion, and the fixing sheet is fixed on the first upper portion.

Further, the spring rod produces elastic deformation in axial direction of the spring rod; each of the at least one roller unit retracts into each of the at least one first cavity respectively when the pressure is applied on the at least one roller unit.

Further, the roller box further includes foldable handle, the foldable handle is folded in handle chamber.

Further, the handle chamber is U-shaped groove disposed on upper part of the first sidewall, the width of the U-shaped grove is substantially equal to the length of the first corner edge.

Further, the handle chamber is bar groove disposed on the openable top surface close to the connecting part of the openable top surface and the first sidewall.

Further, the connection between the fixing sheet and the first upper portion is threaded connection, welded connection or glued connection.

The present invention further provides an assembly including roller box and the matter to be transported; the roller box includes the sealed box with openable top surface and at least one roller unit; the sealed box further includes at least one first cavity and at least one second cavity; the at least one roller unit is disposed in the at least one first cavity; the matter is packaged in the roller box.

Further, the matter is rolled into the cylindrical shape with diameter substantially equal to the width of the sealed box and the length substantially equal to the height of the sealed box and placed into the sealed box through the openable top surface.

Further, the matter is the mattress or the tatami, other matters can be transported as well.

The present invention further provides a roller box assembly including first roller box and second roller box. The first roller box includes first side and second side opposite to the first side, and the second roller box includes third side and fourth side opposite to the third side. The first roller box furthers includes at least one first roller unit arranged in at least one first cavity in the first side and at least one second cavity arranged in the second side; the at least one first roller unit is symmetrically disposed on the first side; each of the at least one first cavity corresponds to each of the at least one second cavity. The second roller box further includes at least one third roller unit arranged in at least one third cavity in the third side and at least one fourth cavity arranged in the fourth side; the at least one third roller unit is symmetrically disposed on the third side; each of the at least one third cavity corresponds to each of the at least one fourth cavity.

Further, the second roller box is placed parallel to the first roller box, the at least one third cavity of the second roller box corresponds to the at least one second cavity of the first roller box; and the at least one third roll unit is partly disposed in the at least one second cavity respectively.

Further, the third side of the second roller box is tightly next to the second side of the first roller box so as to sleeve at least one convex part of the at least one third roller unit of the second roller box into the at least one second cavity of the first roller box.

Further, the second roller box is stacked on the first roller box, the at least one third roller unit is totally disposed in the at least one third cavity along the stack direction.

Further, bottom surface of the second roller box is tightly close to top surface of the first roller box; the at least one third roller unit totally retracts into the at least one third cavity along the stack direction when the pressure is applied on the at least one third roller unit.

The present invention further provides an assembly including roller box, and mattress to be transported; the roller box includes box portion and at least one roller unit; the box portion includes openable top surface, a plurality of sidewalls and bottom surface; first of the plurality of sidewalls meets the bottom surface to define corner edge; the at least one roller unit includes wheel with sliding spring shaft, two channels and fixing seat, the two channels are disposed in the fixing seat, and the sliding spring shaft can move along the two channels; the at least one roller unit is disposed along the corner edge through the fixing seat; and the mattress is placed into the roller box through the openable top surface.

Further, the connection between the fixing seat and the box portion has bolted connection, other type of connection can be used as well.

Further, the at least one roller unit includes a plurality of roller units, the plurality of roller units are symmetrically arranged along the corner edge; the plurality of roller units comprises different and independent sliding spring shafts.

The present invention further provides an assembly including roller box and the mattress to be transported; the roller box includes the sealed box and at least one roller unit, the sealed box includes openable top surface, first sidewall and bottom surface; the first sidewall meets the bottom surface to define first corner edge; at least one cavity is formed around the first corner edge; the at least one roller unit is disposed in the at least one cavity.

Further, the at least one roller unit includes a plurality of roller units, the at least one cavity includes a plurality of cavities symmetrically arranged around the first corner edge.

Further, each of the plurality of roller units includes wheel with universal joint, and fixing sheet. The roller unit can be installed in the cavity through the fixing sheet.

Further, the structure of the roller unit is foldable, the roller unit is disposed in the cavity through connecting rod. The connecting rod includes first connecting rod, second connecting rod and third connecting rod. First end of the first connecting rod and first end of the second connecting rod are fixedly connected in the cavity, second end of the first connecting rod and second end of the second connecting rod are detachably connected to first end of the third connecting rod and second end of the third connecting rod, respectively. The roller unit is disposed on the third connecting rod and can rotate around the third connecting rod. The first connecting rod and the second connecting rod can swing around the first end of the first connecting rod and first end of the second connecting rod.

Further, the roller box includes foldable handle, the foldable handle is folded in handle chamber. The handle chamber is U-shaped groove disposed on upper part of the first sidewall, the width of the U-shaped grove is substantially equal to the length of the first corner edge.

Further, the roller box includes foldable handle, the foldable handle is folded in handle chamber. The handle chamber is bar groove disposed on the openable top surface close to the connecting part of the openable top surface and the first sidewall.

Compared with the prior art, the advantages of the present invention are as follows. Adding roller units on the external packing of the goods to be transported significantly saves resources during the transportation and improve the transportation efficiency, because there is no need to resort to external forces when carrying the goods. In addition, due to the spring rod in the roller unit, only elastic deformation is produced in the axial direction, when a pressure is applied on the roller units, the roller units can totally retract into the cavities from the bottom surface to make the box more stable. At the same time, roller units' convex parts from sidewalls of box can completely fit another neighboring box's cavities that are not installed with roller units. This arrangement saves transportation cost.

### BRIEF DESCRIPTION OF THE DRAWINGS

FIG. 1 is a schematic diagram of a roller box according to the first embodiment of the present invention.

FIG. 2 is a schematic diagram of a roller box according to the second embodiment of the present invention.

FIG. 3 is a schematic diagram of a roller box according to the third embodiment of the present invention.

FIG. 4 is a schematic diagram of a roller unit according to the fourth embodiment of the present invention.

FIG. 5 is a schematic diagram of a roller box according to the fifth embodiment of the present invention.

FIG. 6 is a schematic diagram of a roller box according to the sixth embodiment of the present invention.

FIG. 7 is a schematic diagram of a roller box according to the seventh embodiment of the present invention.

FIG. 8 is a schematic diagram of an assembly according to the eighth embodiment of the present invention.

FIG. 9 is a schematic diagram of a roller box assembly according to the ninth embodiment of the present invention.

FIG. 10 is a schematic diagram of a roller box assembly according to the tenth embodiment of the present invention.

FIG. 11 is a schematic diagram of a roller box assembly according to the eleventh embodiment of the present invention.

FIG. 12 is a schematic diagram of an assembly from the bottom and side view of the box portion when the roller box is in use according to the twelfth embodiment of the present invention.

FIG. 13 is a section view of a roller unit according to the twelfth embodiment.

FIG. 14 is a schematic diagram of an assembly from the bottom and side view of the box portion when the roller box is not in use according to the twelfth embodiment of the present invention.

FIG. 15 is a schematic diagram of an assembly according to the thirteenth embodiment of the present invention.

FIG. 16 is a schematic diagram of an assembly according to the fourteenth embodiment of the present invention.

FIG. 17 is a schematic diagram of an assembly according to the fifteenth embodiment of the present invention.

FIG. 18 is a schematic diagram of an assembly according to the sixteenth embodiment of the present invention.

FIG. 19 is a schematic diagram of the seventeenth embodiment of the present invention.

FIG. 20 is a schematic diagram of the eighteenth embodiment of the present invention.

### DETAILED DESCRIPTION

The present invention will be further described below in detail with reference to the accompanying drawings and embodiments. However, it should be clear that the specific embodiments described herein are used only to explain the present invention, and are not intended to limit the scope of the invention.

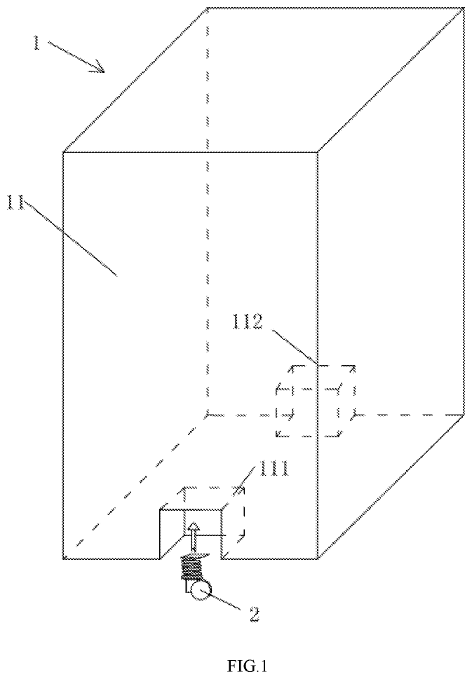

Referring to FIG. 1, a schematic diagram of a roller box according to the first embodiment of the present invention is shown. The roller box 1 includes sealed box 11 and at least one roller unit 2. The sealed box 11 includes at least one first cavity 111 and at least one second cavity 112; the at least one roller unit 2 is disposed in the at least one first cavity 111. While certain configuration is shown in FIG. 1, the size of the first cavity 111 can be any size. The size of the second cavity 112 can be any size. The size of the roller unit 2 can be any size. In an alternative embodiment to the first embodiment, the second cavity 112 can be omitted, where the sealed box 11 only has the first cavity 111 and the roller unit 2.

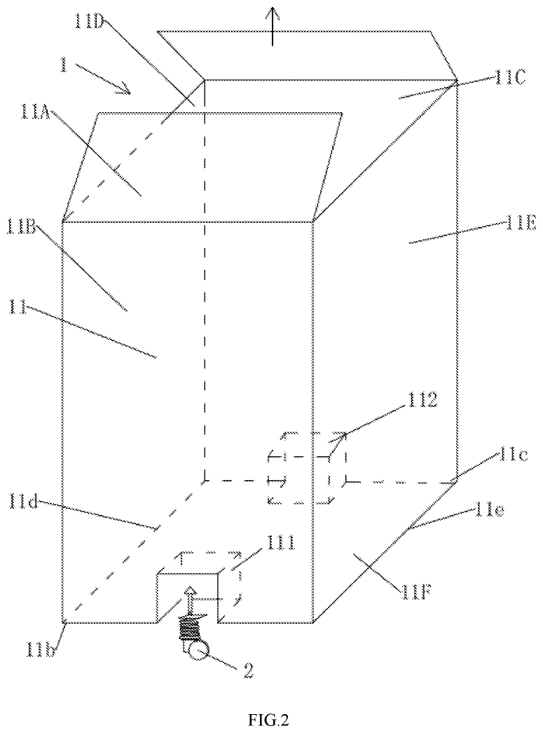

Referring to FIG. 2, a schematic diagram of a roller box according to the second embodiment of the present invention is shown. In the second embodiment, the structure of the second embodiment is similar to the structure of the first embodiment, the only difference is that the sealed box 11 includes openable top surface 11A, first sidewall 11B, second sidewall 11C, third sidewall 11D, fourth sidewall 11E and bottom surface 11F; the first sidewall 11B is opposite to the second sidewall 11C, and the third sidewall 11D is opposite to the fourth sidewall 11E; the bottom surface 11F respectively meets the first sidewall 11B, the second sidewall 11C, the third sidewall 11D and the fourth sidewall 11E to define first corner edge 11b, second corner edge 11c, third corner edge 11d and fourth corner edge 11e. While certain configuration is shown in FIG. 2, the size of the first cavity 111 can be any size. The size of the second cavity 112 can be any size. The size of the roller unit 2 can be any size. In an alternative embodiment to the second embodiment, the second cavity 112 can be omitted, where the sealed box 11 only has the first cavity 111 and the roller unit 2.

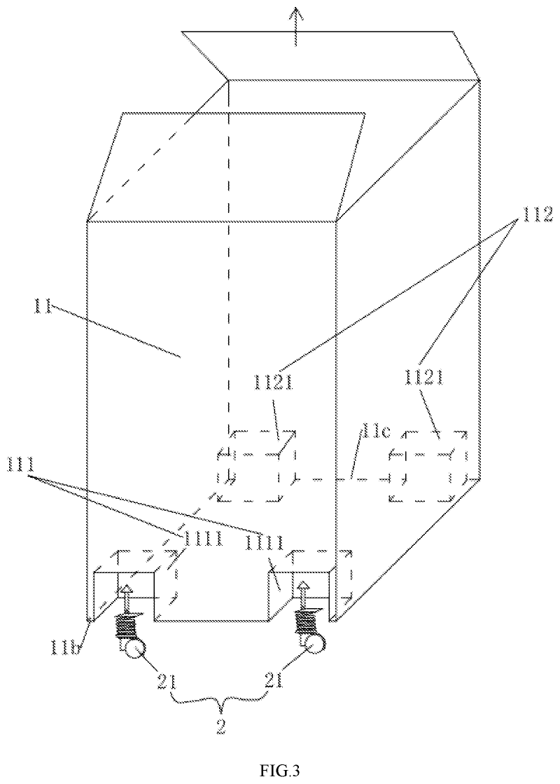

Referring to FIG. 3, a schematic diagram of a roller box according to the third embodiment of the present invention is shown. In the third embodiment, the structure of the third embodiment is similar to the structure of the second embodiment, the only difference is that the at least one roller unit 2 includes a plurality of roller units 21, the at least one first cavity 111 includes first set of cavities 1111, and the at least one second cavity 112 includes second set of cavities 1121; the plurality of roller units 21 are disposed in the first set of cavities 1111. The first set of cavities 1111 are symmetrically formed by concaving inward the sealed box 11 from the first corner edge 11b, and the second set of cavities 1121 are symmetrically formed by concaving inward the sealed box 11 from the second corner edge 11c; the first set of cavities 1111 and the second set of cavities 1121 are symmetrically arranged. While certain configuration is shown in FIG. 3, the size of the first cavity 111 can be any size. The size of the second cavity 112 can be any size. The size of the roller unit 2 can be any size. In an alternative embodiment to the third embodiment, the second cavity 112 can be omitted, where the sealed box 11 only has the first cavity 111 and the roller unit 2.

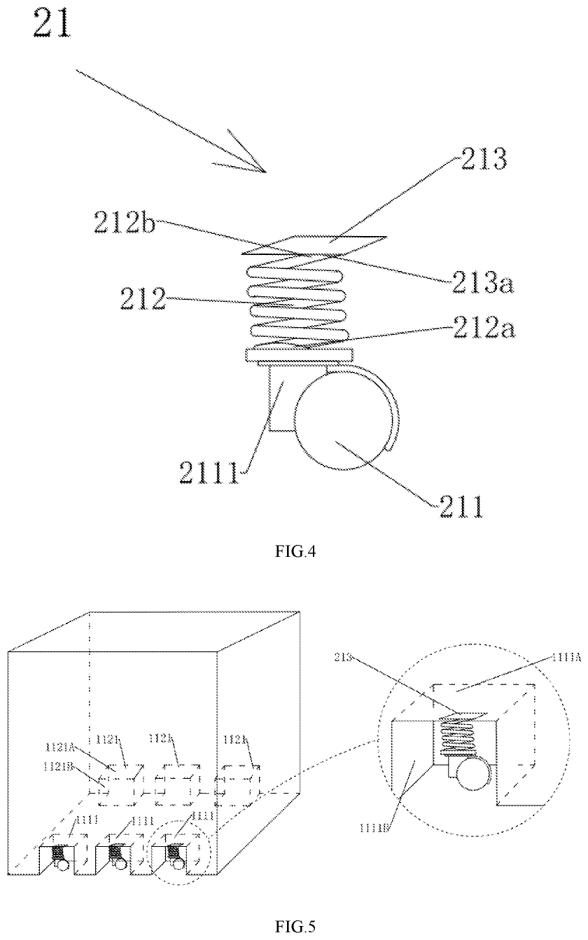

Referring to FIG. 4, a schematic diagram of a roller unit according to the fourth embodiment of the present invention is shown. In the fourth embodiment, the structure of the fourth embodiment is similar to the structure of the third embodiment, the only difference is that each of the plurality of roller units 21 includes wheel 211 with universal joint 2111, spring rod 212 and fixing sheet 213; first end 212a of the spring rod 212 is coaxially connected to the universal joint 2111 of the wheel 211, and second end 212b of the spring rod 212 is fixedly connected to midpoint 213a of the fixing sheet 213. The size of the first cavity 111 can be any size. The size of the second cavity 112 can be any size. The size of the roller unit 2 can be any size. In an alternative embodiment to the fourth embodiment, the second cavity 112 can be omitted, where the sealed box 11 only has the first cavity 111 and the roller unit 2.

Referring to FIG. 5, a schematic diagram of a roller box according to the fifth embodiment of the present invention is shown. In the fifth embodiment, the structure of the fifth embodiment is similar to the structure of the fourth embodiment, the only difference is that each of the first set of cavities 1111 includes first upper portion 1111A and first side portion 1111B, and each of the second set of cavities 1121 includes second upper portion 1121A and second side portion 1121B, and the fixing sheet 213 is fixed on the first upper portion 1111A. While certain configuration is shown in FIG. 5, the size of each of the first set of cavities 1111 can be any size. The size of each of the second set of cavities 1121 can be any size. The size of the roller unit can be any size. In an alternative embodiment to the fifth embodiment, the second set of cavities 1121 can be omitted, where the sealed box 11 only has the first set of cavities 1111 and the roller unit.

In the embodiments listed above, the spring rod 212 produces elastic deformation in axial direction of the spring rod 212; roller unit 21 retracts into first cavities 1111 respectively when the pressure is applied on the roller units 21. In this arrangement, the roller units can retract into the cavities when placing the roller box during the transportation, it not only effectively save the transportation space, but also greatly improve the stability of the roller box.

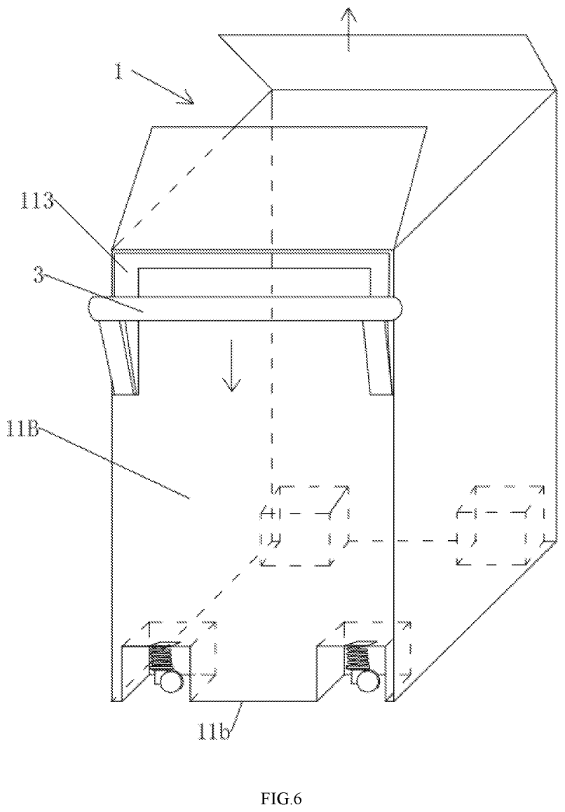

Referring to FIG. 6, a schematic diagram of a roller box according to the sixth embodiment of the present invention is shown. In the sixth embodiment, the structure of the sixth embodiment is similar to the structure of the second embodiment, the only difference is that the roller box 1 of the sixth embodiment further includes foldable handle 3, the foldable handle 3 is folded in handle chamber. The handle chamber in the sixth embodiment is U-shaped groove 113 disposed on upper part of the first sidewall 11B, the width of the U-shaped grove 113 is substantially equal to the length of the first corner edge 11b. While certain configuration is shown in FIG. 6, the size of the first cavity 111 can be any size. The size of the second cavity 112 can be any size. The size of the roller unit 2 can be any size. In an alternative embodiment to the sixth embodiment, the second cavity 112 can be omitted, where the sealed box 11 only has the first cavity 111 and the roller unit 2.

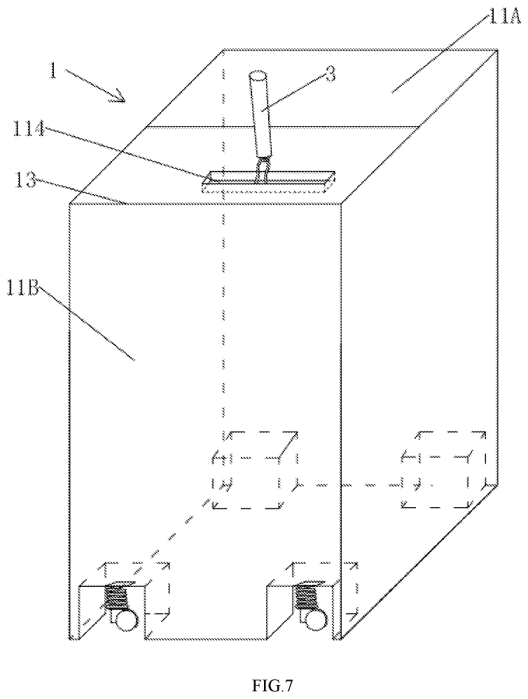

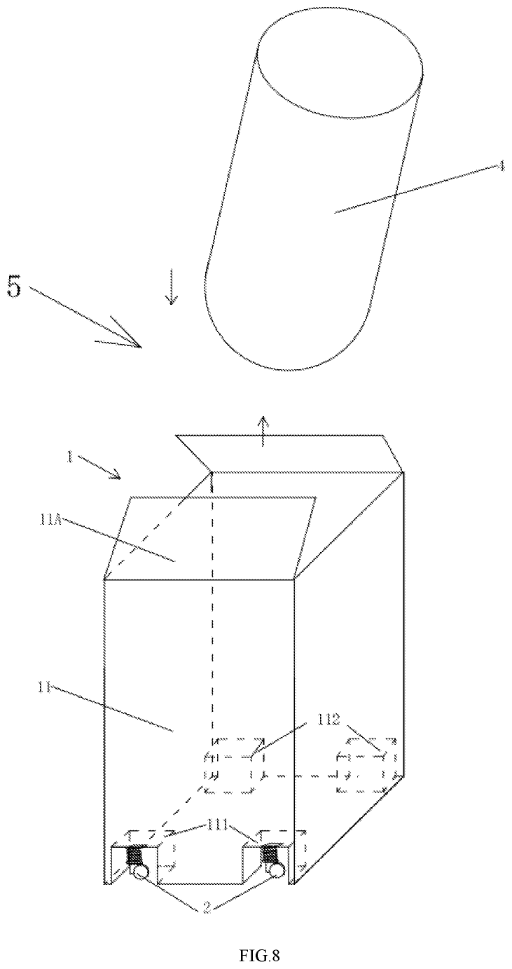

Referring to FIG. 7, a schematic diagram of a roller box according to the seventh embodiment of the present invention is shown. In the seventh embodiment, the structure of the seventh embodiment is similar to the structure of the second embodiment, the only difference is that the roller box 1 of the seventh the embodiment further includes foldable handle 3, the foldable handle 3 is folded in handle chamber. The handle chamber in the seventh embodiment is bar groove 114 disposed on the openable top surface 11A close to the connecting part 13 of the openable top surface 11A and the first sidewall 11B. While certain configuration is shown in FIG. 7, the size of the first cavity 111 can be any size. The size of the second cavity 112 can be any size. The size of the roller unit 2 can be any size. In an alternative embodiment to the seventh embodiment, the second cavity 112 can be omitted, where the sealed box 11 only has the first cavity 111 and the roller unit 2.

In the embodiments listed above, the connection between the fixing sheet 213 and the first upper portion 1111A is threaded connection, welded connection or glued connection. Other connection can be used as well. The selection of the connection type can make the roller box stronger and more durable. In addition, the design of the foldable handle makes the roller box prone to be used conveniently and save transportation space.

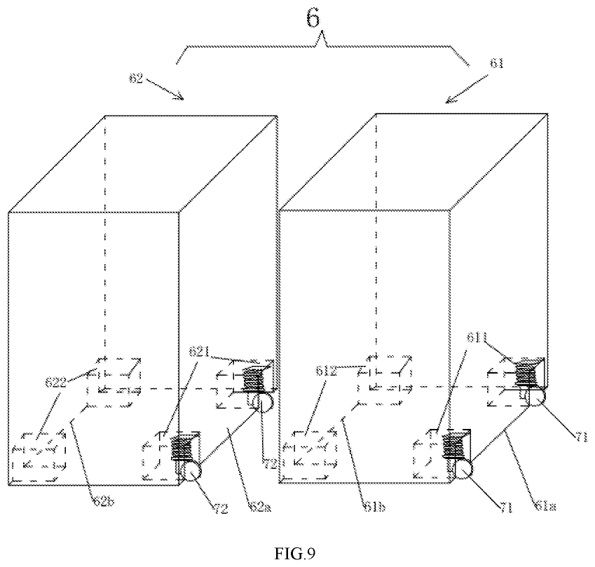

Referring to FIG. 8, a schematic diagram of an assembly according to the eighth embodiment of the present invention is shown. In the eighth embodiment, assembly 5 includes roller box 1 and the matter 4 to be transported; the roller box 1 includes the sealed box 11 with openable top surface 11A and at least one roller unit 2; the sealed box 11 includes at least one first cavity 111 and at least one second cavity 112; the at least one roller unit 2 is disposed in the at least one first cavity 111; the matter 4 is packaged in the roller box 1. The matter 4 is rolled into the cylindrical shape with diameter substantially equal to the width of the sealed box 11 and the length substantially equal to the height of the sealed box 11 and placed into the sealed box 11 through the openable top surface 11A. Matter 4 is the mattress or the tatami, other matters can be transported by the roller box. Matter 4 to be transported rolled into the cylindrical shape with diameter substantially equal to the width of the sealed box 11 and the length substantially equal to the height of the sealed box 11, which makes matter packaged in the roller box not easy to move and maximizes the use of transportation space. While certain configuration is shown in FIG. 8, the size of the first cavity 111 can be any size. The size of the second cavity 112 can be any size. The size of the roller unit 2 can be any size. In an alternative embodiment to the eighth embodiment, the second cavity 112 can be omitted, where the sealed box 11 only has the first cavity 111 and the roller unit 2.

Referring to FIG. 9, a schematic diagram of a roller box assembly according the ninth embodiment of the present invention is shown. The ninth embodiment discloses a roll box assembly with two roller boxes of the present invention. It can be seen from FIG. 9 that roller box assembly 6 including first roller box 61 and second roller box 62. The first roller box 61 includes first side 61a and second side 61b opposite to the first side 61a, and the second roller 62 box includes third side 62a and fourth side 62b opposite to the third side 62a. The first roller box 61 furthers includes at least one first roller unit 71 arranged in at least one first cavity 611 in the first side 61a and at least one second cavity 612 arranged in the second side 61b. The at least one first roller unit 71 are symmetrically disposed on the first side 61a; each of the at least one first cavity 611 corresponds to each of the at least one second cavity 612. The second roller box 62 further includes at least one third roller unit 72 arranged in at least one third cavity 621 in the third side 62a and at least one fourth cavity 622 arranged in the fourth side 62b. The at least one third roller unit 72 are symmetrically disposed on the third side 62a; each of the at least one third cavity 621 corresponds to each of the at least one fourth cavity 622. While certain configuration is shown in FIG. 9, the size of the first cavity 611 can be any size. The size of the second cavity 612 can be any size. The size of the third cavity 621 can be any size. The size of the fourth cavity 622 can be any size. The size of the first roller unit 71 can be any size. The size of the third roller unit 72 can be any size. In an alternative embodiment to the ninth embodiment, the second cavity 612 and the fourth cavity 622 can be omitted, where the first roller box 61 only has the first cavity 611 and the first roller unit 71, and the second roller box 62 only has the third cavity 621 and the third roller unit 72.

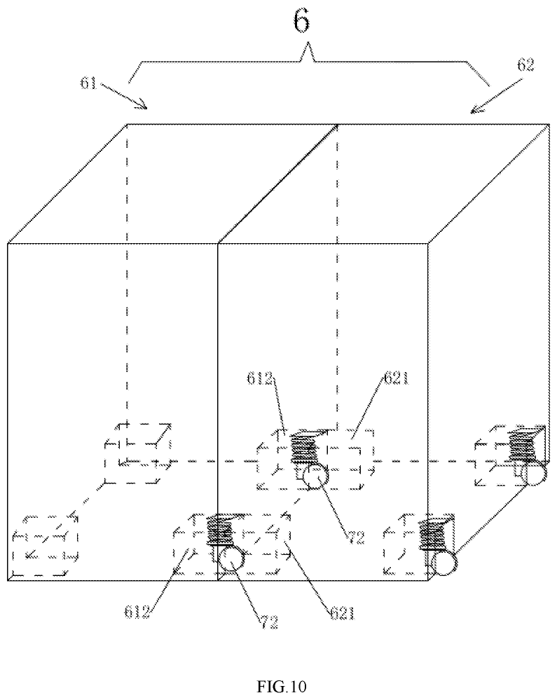

Referring to FIG. 10, a schematic diagram of a roller box assembly according to the tenth embodiment of the present invention is shown. In the tenth embodiment, the structure of the tenth embodiment is similar to the structure of the ninth embodiment, the only difference is that the second roller box 62 is placed adjacent and parallel to the first roller box 61 in the tenth embodiment. The at least one third cavity 621 of the second roller box 62 corresponds to the at least one second cavity 612 of the first roller box 61; and the at least one third roll unit 72 are partly disposed in the at least one second cavity 612 respectively. Preferably, the third side 62a of the second roller box 62 is tightly next to the second side 61b of the first roller box 61 so as to sleeve at least one convex part 721 of the at least one third roller unit 72 of the second roller box 62 into the at least one second cavity 612 of the first roller box 61. While certain configuration is shown in FIG. 10, the size of the first cavity 611 can be any size. The size of the second cavity 612 can be any size. The size of the third cavity 621 can be any size. The size of the fourth cavity 622 can be any size. The size of the first roller unit 71 can be any size. The size of the third roller unit 72 can be any size. In an alternative embodiment to the tenth embodiment, the second cavity 612 and the fourth cavity 622 can be omitted, where the first roller box 61 only has the first cavity 611 and the first roller unit 71, and the second roller box 62 only has the third cavity 621 and the third roller unit 72.

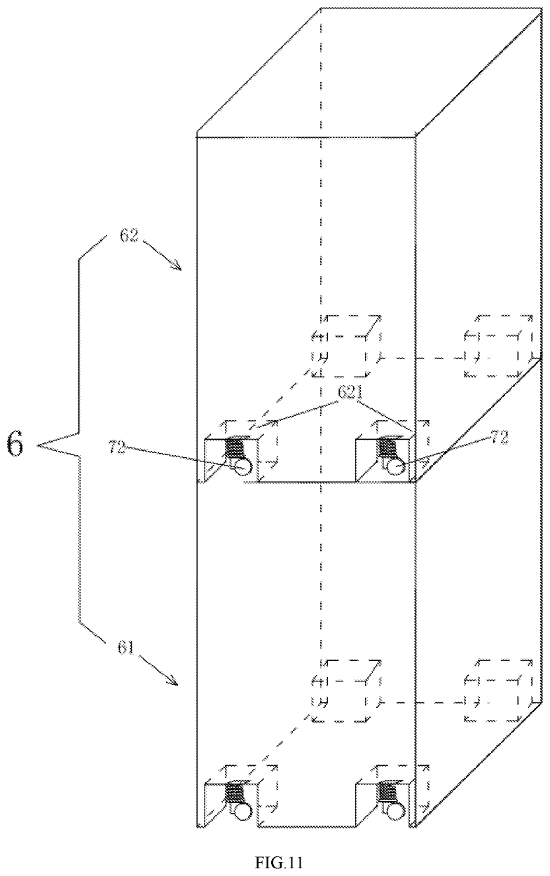

Referring to FIG. 11, a schematic diagram of a roller box assembly according to the eleventh embodiment of the present invention is shown. In the eleventh embodiment, the structure of the eleventh embodiment is similar to the structure of the tenth embodiment, the only difference is that the second roller box 62 is stacked on the top of the first roller box 61. Since there is pressure applied on the at least one third roller unit 72, the at least one third roller unit 72 is totally disposed in the at least one third cavity 621 along the stack direction. Preferably, bottom surface of the second roller box 62 is tightly close to top surface of the first roller box 61; the at least one third roller unit 72 totally retracts into the at least one third cavity 621 along the stack direction when the pressure is applied on the at least one third roller unit 72. While certain configuration is shown in FIG. 11, the size of the first cavity 611 can be any size. The size of the second cavity 612 can be any size. The size of the third cavity 621 can be any size. The size of the fourth cavity 622 can be any size. The size of the first roller unit 71 can be any size. The size of the third roller unit 72 can be any size. In an alternative embodiment to the eleventh embodiment, the second cavity 612 and the fourth cavity 622 can be omitted, where the first roller box 61 only has the first cavity 611 and the first roller unit 71, and the second roller box 62 only has the third cavity 621 and the third roller unit 72.

In the embodiments listed above, due to the existing of the spring rod structure and the cavities arranged in the box, the roller units can be completely retracted into the box along the axial direction of the spring rod and the convex parts of the roller units can be sleeved into the cavities without roller units in another roller box. The cavity is disposed on the corner of the roller box. The handle is disposed inside the handle chamber. This arrangement effectively saves transportation space and resources.

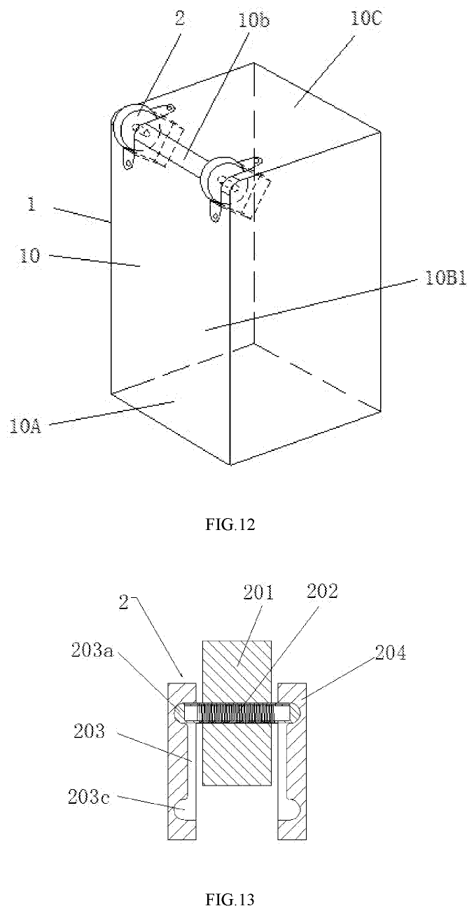

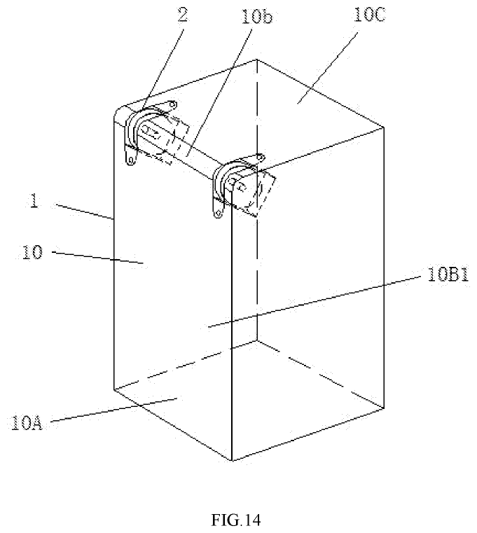

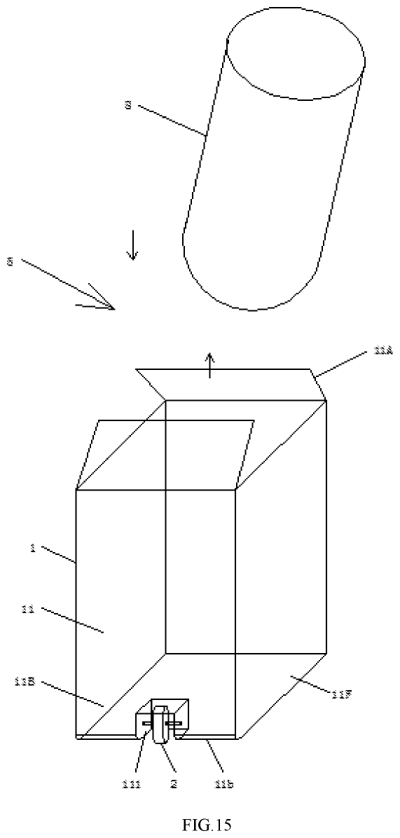

Referring to FIGS. 12, 13 and 14, schematic diagrams of an assembly according to the twelfth embodiment of the present invention is shown. In the twelfth embodiment, an assembly 5 includes roller box 1, and mattress 8 (not shown in the figure) to be transported; the roller box 1 includes box portion 10 and two roller units 2; the box portion 10 includes openable top surface 10A, a plurality of sidewalls 10B and bottom surface 10C; first of the plurality of sidewalls 10B1 meets the bottom surface 10C to define corner edge 10b. As shown in FIG. 13, each of the two roller unit 2 includes wheel 201 with sliding spring shaft 202, two channels 203 and fixing seat 204, the two channels 203 are disposed in the fixing seat 204, and the sliding spring shaft 202 can move along the two channels 203; the two roller units 2 are disposed along the corner edge 10b through the fixing seat 204; and the mattress 8 is placed into the roller box 1 through the openable top surface 10A. Two ends of each of the channels 203 are respectively provided with a first concave 203a and a second concave 203b, the first concave 203a is closer to the internal of the box portion 10 than the second concave 203b. As shown in FIG. 14, when the roller box 1 is not in use, the sliding spring shaft 202 moves to the position of the first concave 203a along the channel 203, so that the sliding spring shaft 202 can be locked in the first concave 203a and the roller unit 2 is completely received in the box portion 10. As shown in FIG. 12, when the roller box 1 is in use, the sliding spring shaft 202 moves to the position of the second concave 203b along the channel 203, so that the sliding spring shaft 202 can be locked in the second concave 203b and the roller unit 2 protrudes from the corner edge 10b of the box portion. While certain configuration is shown in FIG. 12 and FIG. 14, the size of the roller unit 2 can be any size. The two roller units 2 can be symmetrically or asymmetrically arranged along the corner edge 10b; and the two roller units 2 can have different or common sliding spring shafts. Roller unit 2 can be wheel, or wheel having universal joint or any equivalent of these that a skilled person could use.

Referring to FIG. 15, a schematic diagram of an assembly according to the thirteenth embodiment of the present invention is shown. In the thirteenth embodiment, assembly 5 includes roller box 1 and the mattress 8 to be transported; the roller box 1 includes the sealed box 11 and at least one roller unit 2, the sealed box 11 includes openable top surface 11A, first sidewall 11B and bottom surface 11F; the first sidewall 11B meets the bottom surface 11F to define first corner edge 11b; at least one first cavity 111 is formed around the first corner edge 11b; the at least one roller unit 2 is disposed in the at least one first cavity 111. While certain configuration is shown in FIG. 15, the size of the roller unit 2 can be any size, and the size of the first cavity 111 can be any size.

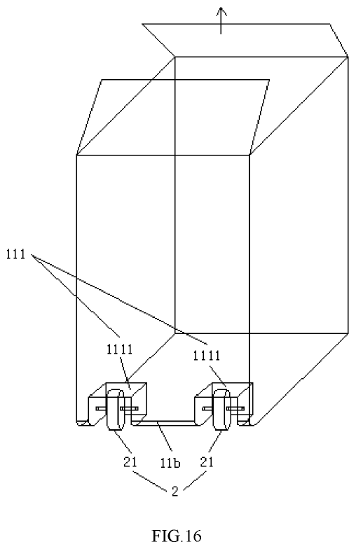

Referring to FIG. 16, a schematic diagram of an assembly according to the fourteenth embodiment of the present invention is shown. In the fourteenth embodiment, the structure of the fourteenth embodiment is similar to the structure of the thirteenth embodiment, the only difference is that the at least one roller unit 2 includes a plurality of roller units 21, the at least one first cavity 111 includes a plurality of cavities 1111 symmetrically arranged around the first corner edge 11b. While certain configuration is shown in FIG. 16, the size of the roller unit 21 can be any size, and the size of the cavity 1111 can be any size.

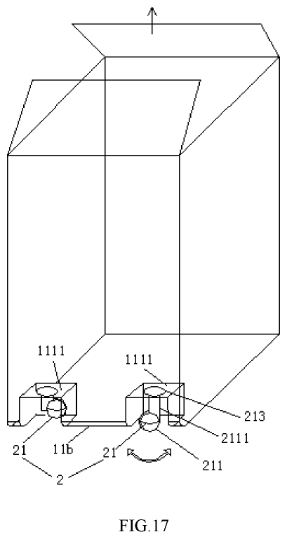

Referring to FIG. 17, a schematic diagram of an assembly according to the fifteenth embodiment of the present invention is shown. In the fifteenth embodiment, the structure of the fifteenth embodiment is similar to the structure of the fourteenth embodiment, the only difference is that each of the plurality of roller units 21 includes wheel 211 with universal joint 2111, and fixing sheet 213. The roller unit 21 can be installed in the cavity 1111 through the fixing sheet 213. Each of the roller units 21 can rotate independently in the cavity 1111. When the roller box is not in use, the roller unit 21 can rotate toward the cavity 1111 to be completely received. When the roller box is in use, the roller unit 21 can rotate out of the cavity 1111 from the first corner edge 11b. While certain configuration is shown in FIG. 17, the size of the cavity 1111 can be any size. The size of the roller unit 21 can be any size.

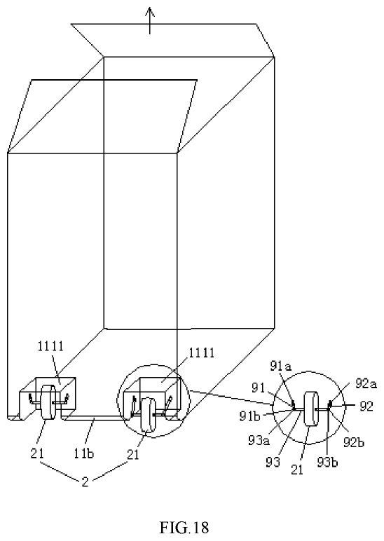

Referring FIG. 18, a schematic diagram of an assembly according to the sixteenth embodiment of the present invention is shown. In the sixteenth embodiment, the structure of the sixteenth embodiment is similar to the structure of the fourteenth embodiment, the only difference is that the structure of the roller unit 21 is foldable, the roller unit 21 is disposed in the cavity 1111 through connecting rod 9. The connecting rod 9 includes first connecting rod 91, second connecting rod 92 and third connecting rod 93. First end 91a of the first connecting rod 91 and first end 92a of the second connecting rod 92 are fixedly connected in the cavity 1111, second end 91b of the first connecting rod 91 and second end 92b of the second connecting rod 92 are detachably connected to first end 93a of the third connecting rod 93 and second end 93b of the third connecting rod 93, respectively. The roller unit 21 is disposed on the third connecting rod 93 and can rotate around the third connecting rod 93. The first connecting rod 91 and the second connecting rod 92 can swing around the first end 91a of the first connecting rod 91 and first end 92a of the second connecting rod 92, when the roller box is not in use, the roller unit 21 can be pushed inward the cavity 1111 to be completely received, when the roller box is in use, the roller unit 21 can be pulled out from the first corner edge 11b. While certain configuration is shown in FIG. 18, the size of the cavity 1111 can be any size, and the size of the roller unit 21 can be any size.

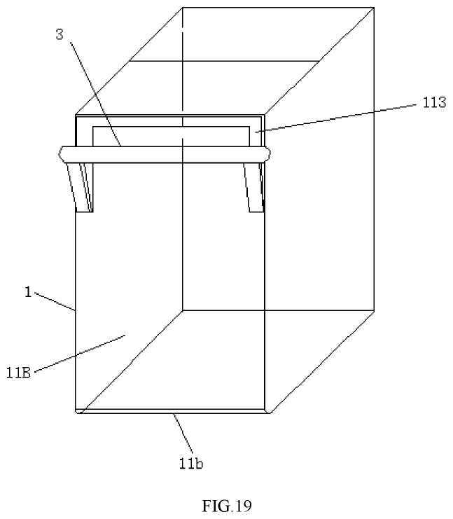

Referring to FIG. 19, a schematic diagram of the seventeenth embodiment of the present invention is shown. In the seventeenth embodiment, the structure of the seventeenth embodiment is similar to the structure of the above listed embodiments, the only difference is that the roller box 1 includes foldable handle 3, the foldable handle 3 is folded in handle chamber. The handle chamber in the sixteenth embodiment is U-shaped groove 113 disposed on upper part of the first sidewall 11B, the width of the U-shaped grove 113 is substantially equal to the length of the first corner edge 11b.

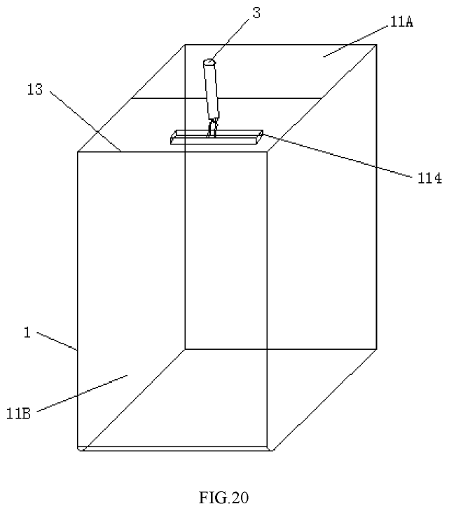

Referring to FIG. 20, a schematic diagram of the eighteenth embodiment of the present invention is shown. In the eighteenth embodiment, the structure of the eighteenth embodiment is similar to the structure of the above listed embodiments, the only difference is that the roller box 1 includes foldable handle 3, the foldable handle 3 is folded in handle chamber. The handle chamber in the seventeenth embodiment is bar groove 114 disposed on the openable top surface 11A close to the connecting part 13 of the openable top surface 11A and the first sidewall 11B.

In the embodiments listed above, the matter 8 is rolled into the cylindrical shape with diameter substantially equal to the width of the box portion 10 or the sealed box 11 and the length substantially equal to the height of box portion 10 or the sealed box 11 and placed into the box portion 10 or the sealed box 11 through the openable top surface 11A. Matter 8 to be transported rolled into the cylindrical shape with diameter substantially equal to the width of the box portion 10 or the sealed box 11 and the length substantially equal to the height of the box portion 10 of the sealed box 11, which makes matter packaged in the roller box not easy to move and maximizes the use of transportation space.

The foregoing descriptions are merely preferred embodiments of the present invention, and are not used to limit the scope of the present invention. Any modifications, equivalent replacements and improvements made within the spirit and principle of the present invention should be included in the protection scope of the present invention.

We claim:

1. A roller box, comprising:
a sealed box, and
at least one roller unit;
wherein
the sealed box comprises at least one first cavity and at least one second cavity;
the at least one roller unit is disposed in the at least one first cavity.

2. The roller box of claim 1, wherein
the sealed box comprises an openable top surface, a first sidewall, a second sidewall, a third sidewall, a fourth sidewall and a bottom surface;
the first sidewall is opposite to the second sidewall, the third sidewall is opposite to the fourth sidewall;
the bottom surface respectively meets the first sidewall, the second sidewall, the third sidewall and the fourth sidewall to define a first corner edge, a second corner edge, a third corner edge and a fourth corner edge.

3. The roller box of claim 2, wherein
the at least one roller unit comprises a plurality of roller units, the at least one first cavity comprises a first set of cavities, and the at least one second cavity comprises a second set of cavities; the plurality of roller units are disposed in the first set of cavities.

4. The roller box of claim 3, wherein
the first set of cavities are symmetrically formed by concaving inward the sealed box from the first corner edge, and the second set of cavities are symmetrically formed by concaving inward the sealed box from the second corner edge;
the first set of cavities and the second set of cavities are symmetrically arranged.

5. The roller box of claim 1, wherein
each of the at least one roller unit comprises a wheel with a universal joint, a spring rod and a fixing sheet;
a first end of the spring rod is coaxially connected to the universal joint of the wheel, and a second end of the spring rod is fixedly connected to a midpoint of the fixing sheet.

6. The roller box of claim 5, wherein each of the at least one first cavity comprises a first upper portion and a first side portion, and each of the at least one second cavity comprises a second upper portion and a second side portion, and the fixing sheet is fixed on the first upper portion.

7. The roller box of claim 5, wherein the spring rod produces an elastic deformation in an axial direction of the spring rod; each of the at least one roller unit retracts into each of the at least one first cavities respectively when a pressure is applied on the at least one roller unit.

8. The roller box of claim 2, further comprising a foldable handle, wherein the foldable handle is folded in a handle chamber.

9. The roller box of claim 8, wherein
the handle chamber is a U-shaped groove disposed on an upper part of the first sidewall, a width of the U-shaped grove is substantially equal to a length of the first corner edge.

10. The roller box of claim 8, wherein
the handle chamber is a bar groove disposed on the openable top surface close to a connecting part of the openable top surface and the first sidewall.

11. The roller box of claim 6, wherein a connection between the fixing sheet and the first upper portion is a threaded connection, a welded connection or a glued connection.

12. An assembly comprising:
a roller box, and
a matter to be transported;
wherein
the roller box comprises a sealed box with an openable top surface and at least one roller unit; the sealed box comprises at least one first cavity and at least one second cavity; the at least one roller unit is disposed in the at least one first cavity;
the matter is packaged in the roller box.

13. The assembly of claim 12, wherein the matter is rolled into a cylindrical shape with a diameter substantially equal to a width of the sealed box and a length substantially equal to a height of the sealed box and placed into the sealed box through the openable top surface.

14. The assembly of claim 12, wherein the matter is a mattress or a tatami.

15. A roller box assembly, comprising:
a first roller box and a second roller box, wherein
the first roller box comprises a first side and a second side opposite to the first side, and the second roller box comprises a third side and a fourth side opposite to the third side;
the first roller box furthers comprises at least one first roller unit arranged in at least one first cavity in the first side and at least one second cavity arranged in the second side; the at least one first roller unit is symmetrically disposed on the first side; each of the at least one first cavity corresponds to each of the at least one second cavity;
the second roller box further comprises at least one third roller unit arranged in at least one third cavity in the third side and at least one fourth cavity arranged in the fourth side; the at least one third roller unit is symmetrically disposed on the third side; each of the at least one third cavity corresponds to each of the at least one fourth cavity.

16. The roller box assembly of claim 15, wherein the second roller box is placed parallel to the first roller box, the at least one third cavity of the second roller box corresponds to the at least one second cavity of the first roller box; and the at least one third roll unit is partly disposed in the at least one second cavity respectively.

17. The roller box assembly of claim 16, wherein the third side of the second roller box is tightly next to the second side of the first roller box so as to sleeve at least one convex part of the at least one third roller unit of the second roller box into the at least one second cavity of the first roller box.

18. The roller box assembly of claim 15, wherein the second roller box is stacked on the first roller box, the at least one third roller unit is totally disposed in the at least third cavity along a stack direction.

19. The roller box assembly of claim 18, wherein a bottom surface of the second roller box is tightly close to a top surface of the first roller box; the at least one third roller unit totally retracts into the at least one third cavity along the stack direction when a pressure is applied on the at least one third roller unit.

20. An assembly comprising:
a roller box, and
a mattress to be transported;
wherein
the roller box comprises a box portion and two roller units; the box portion comprises an openable top surface, a plurality of sidewalls and a bottom surface; a first of the plurality of sidewalls meets the bottom surface to define a corner edge; each of the two roller units comprises a wheel with a sliding spring shaft, a fixing seat and two channels;
the two channels are disposed on the fixing seat, and the sliding spring shaft can move along the two channels;
the two roller units are fixed along the corner edge through the fixing seat; and the mattress is placed into the roller box through the openable top surface.

21. The assembly of claim 20, wherein the two roller units are symmetrically arranged along the corner edge; and each of the two roller units comprise different and independent sliding spring shaft.
